(19) United States
(12) Patent Application Publication
(10) Pub. No.: US 2010/0185816 A1
(43) Pub. Date: Jul. 22, 2010

(54) Multiple Cache Line Size

(76) Inventors: William F. Sauber, Georgetown, TX (US); Mitchell Markow, Hutto, TX (US)

Correspondence Address: HAMILTON & TERRILE, LLP, P.O. BOX 203518, AUSTIN, TX, 78720, US

(21) Appl. No.: 12/356,893

(22) Filed: Jan. 21, 2009

(51) Int. Cl. G06F 12/08; G06F 12/02; G06F 12/00

(52) U.S. Cl. 711/122; 711/136; 711/103; 711/105; 711/E12.022; 711/E12.024; 711/E12.008

(57) ABSTRACT

A mechanism which allows pages of flash memory to be read directly into cache. The mechanism enables different cache line sizes for different cache levels in a cache hierarchy, and optionally, multiple line size support, simultaneously or as an initialization option, in the highest level (largest/slowest) cache. Such a mechanism improves performance and reduces cost for some applications.

### BACKGROUND OF THE INVENTION

1. Field of the Invention

The present invention relates to information handling systems and more particularly to a cache hierarchy which includes different cache line sizes for different cache levels.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to provide information handling systems with a storage hierarchy. Known storage hierarchies can include multiple storage levels include processor cache, dynamic random access memory (DRAM), and disk drives. It is also known to use flash memory to function as a solid state drive (SSD) as well as an intermediate caching store under control of an operation system (OS) or device drivers. Flash memory provides an interesting cost per bit and power point between high capacity disks and DRAM. It is advantageous to provide applications with access to flash via virtual memory and processor caches. However, multiple changes to an information handling system architecture may be desirable to optimize the use of flash memory via virtual memory and processor caches. One of these changes is in the cache hierarchy.

With flash memory devices, the most efficient mode of flash operation is by reading a full page. Flash memory devices pages are large (e.g., 4 Kbytes) relative to units of cache lines (e.g., 64 Bytes) which can match DRAM burst accesses. Also, multiple flash devices (e.g., 8 devices forming a 32 Kbyte page) are likely to be accessed in parallel to boost bandwidth.

When accessing a flash memory, pages of the flash memory are read into dedicated buffers (e.g., external caches) or into intermediate storage in DRAM.

Another issue relating to a storage hierarchy of information handling systems can occur at the DRAM interface of the storage hierarchy. System memory performance and power efficiency are limited by DRAM burst length which in turn is constrained by processor cache line size. It is desirable for the burst duration of the DRAM access to equal the CAS latency. However, in known systems, the burst duration is often shorter than the column address strobe (CAS) latency. This condition can introduce dead time on the interface for page hits. A burst size greater than a cache line size transfers data which is thrown away.

The line size of smaller caches (e.g., a first level (L1) cache having a 32 KB capacity) can not easily be increased (because a larger cache is often slower than a smaller cache) if core efficiency is to be maintained. Also, larger caches (e.g., a third level (L3) cache having an 8 MB capacity) may be able to accommodate some number of larger cache lines. Cache lines up to a page size of a flash memory (e.g., cache lines of greater than 4 KB) could provide value through spatial locality.

Accordingly, it would be desirable to provide a memory architecture which maintains the granularity of the small fast caches while providing an ability to efficiently cache flash or longer DRAM bursts is needed.

### SUMMARY OF THE INVENTION

In accordance with the present invention, a mechanism is set forth which allows pages of flash memory to be read directly into cache. More specifically, the mechanism of the present invention enables different cache line sizes for different cache levels in a cache hierarchy, and optionally, multiple line size support, simultaneously or as an initialization option, in the highest level (largest/slowest) cache. Such a mechanism improves performance and reduces cost for some applications.

A longer burst coupled with a larger cache line can improve the efficiency of DRAM and DRAM interface. Such a system enables a higher level cache to support line sizes which allow efficient DRAM or flash operations and lower level cache line sizes to remain small enough to support speed and granularity requirements. Providing larger line sizes at the higher level cache can also allow longer DRAM bursts which can improve DRAM interface performance.

In certain embodiments, the system supports multiple line sizes by being aware of the access target (e.g., a DRAM or flash memory) and flushing a large line or multiple small lines for a cache line replacement. Additionally, in certain embodiments, the system factors line size into a least recently used (LRU) type algorithm for line replacement. Also in certain embodiments, information regarding the type of target (e.g., whether the target is a DRAM or flash memory) is provided with registers which mirror the memory interface address space partitioning configured at system initialization.

Also in certain embodiments, the highest level cache may be divided into a DRAM and a flash cache. In various embodiments, the system functions with different cache line sizes in different cache levels, multiple cache line sizes in a single cache, and a split cache at the highest level. Additionally, in certain embodiments, the system provides flash support.

More specifically, in one embodiment, the invention relates to a method for optimizing a memory system. The method includes providing the memory system with a memory system cache hierarchy having a plurality of caches, at least one of the caches having a different cache line size; determining a cache line size for each of the plurality of caches; and, optimizing a line size of a storage device based upon the determining a cache line size.

In another embodiment, the invention relates to a memory system comprising a memory system cache hierarchy, the memory system cache hierarchy comprising a plurality of caches, each of the caches having different cache line sizes; and, a cache management system, the cache management system determining a cache line size for at least one of the plurality of caches, where line sizes of a storage device are optimized based upon the determining.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system.

FIG. 2 shows a block diagram of a memory hierarchy of an information handling system.

FIG. 3 shows a flow chart of the initialization of a cache management system.

FIG. 4 shows a flow chart of the operation of a cache management system.

### DETAILED DESCRIPTION

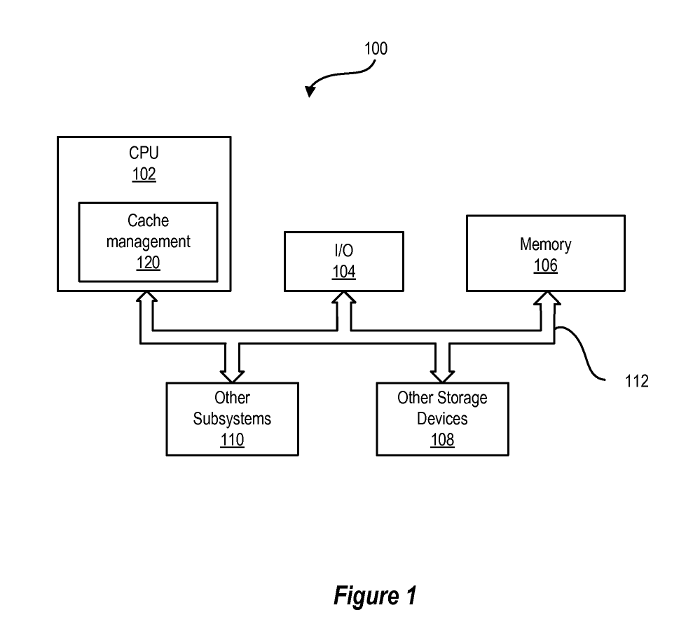

Referring briefly to FIG. 1, a system block diagram of an information handling system 100. The information handling system 100 includes a processor 102 (i.e., a central processing unit (CPU)), input/output (I/O) devices 104, such as a display, a keyboard, a mouse, and associated controllers, memory 106 including both non volatile memory and volatile memory, and other storage devices 108, such as a optical disk and drive and other memory devices, and various other subsystems 110, all interconnected via one or more buses 112. The processor 102 includes a cache management system 120. The cache management system 120 enables different cache line sizes for different cache levels in a cache hierarchy, and optionally, multiple line size support, simultaneously or as an initialization option, in the highest level (largest/slowest) cache. The cache management system 120 improves performance and reduces cost for some applications.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

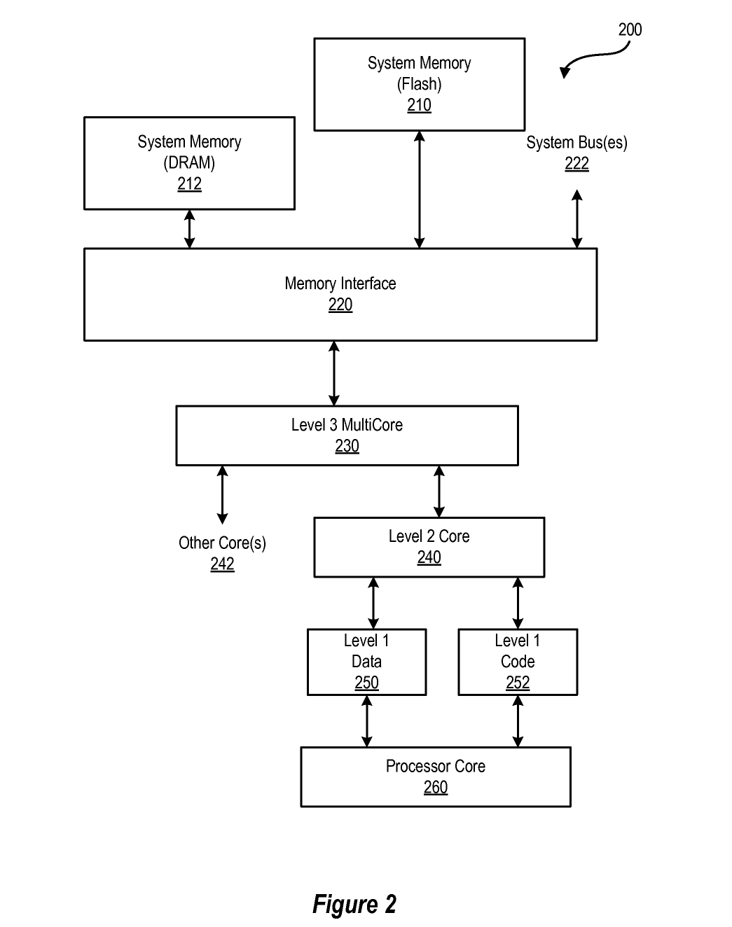

Referring to FIG. 2, a block diagram of a memory hierarchy of the information handling system 100 is shown. More specifically, the cache hierarchy 200 includes a system memory 210 such as a flash memory as well as another system memory 220 such as a DRAM type memory. The system memory 210 and system memory 220 are coupled to a memory interface 220. Other system bus or busses 222 are also coupled to the memory interface. The memory interface is in turn coupled to a cache, such as a level 3 multicore type cache 230. The level 3 cache is coupled to a level 2 core cache 240 as well as other level 2 core caches 242. The level 2 core cache is coupled to a level 1 data cache 250 and a level 1 instruction cache 252, which are in turn coupled to a processor core 260.

In certain embodiments, the system memory 210 communicates with the memory interface via 4 Kbyte burst lengths and the system memory 220 communicates with the memory interface via 64 byte burst lengths. The memory interface provides a physical address resolution function.

Also, in certain embodiments, the level 3 cache 230 includes different cache line size cache lines (e.g., 64 byte and 4 Kbyte line sizes), the level 2 cache 240 includes a 64 byte cache line and the level 1 data cache 250 and level 1 instruction cache 252 include 64 byte cache lines. Also, in certain embodiments, only one type of system memory is present, but the burst length is greater than the cache line size of the level 1 and level 2 caches, but equal to the line size of the level 3 cache.

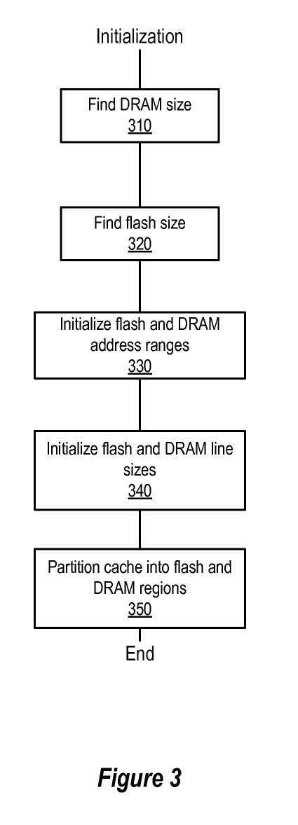

FIG. 3 shows a flow chart of the initialization of a cache management system 120. With the cache management system 120, a longer burst is coupled with a larger cache line to, for example, improve the efficiency of DRAM and DRAM interface or to better match the page size of the flash memory. Such a system enables a higher level cache to support line sizes which allow efficient DRAM or flash operations and lower level cache line sizes to remain small enough to support speed and granularity requirements. Providing larger line sizes at the higher level cache also allows longer DRAM bursts which improves DRAM interface performance.

More specifically, the cache management system 120 starts an initialization process by determining a DRAM size at step 310. The amount of system memory is determined via structures such as a DRAM serial presence detect (SPD) operation as well as via PCI Express configuration space information. Next, at step 320, the cache management system 120 determines a flash size. The amount of flash memory is determined via structures such as a structure equivalent to the DRAM SPD PCI Express configuration space and an Open NAND Flash Interface (ONFI) type operation. In certain system configurations, the flash size may be zero.

The system 120 then proceeds to initialize the flash and DRAM address ranges at step 330. When the system initializes the flash and DRAM address ranges, the cache management system 120 assigns physical address space for each discovered DRAM and flash memory and initializes ranges registers with the physical address space for each DRAM and flash memory.

Next, the system 120 initializes the flash memory and DRAM line sizes at step 340. The DRAM cache line size matches the burst length or alternatively multiple burst support by back to back column address strobe (CAS) operations. A separate flash line size may be based on the flash component page size multiplied by the number of components accessed in parallel. These line sizes need not necessarily be variable. The line sizes could be fixed in a certain system implementation.

Next, the system 120 partitions the cache into flash regions and DRAM regions at step 350. During this step, the cache management system 120 segments the cache into DRAM and flash regions. Examples for setting these regions can include using inputs from BIOS settings (e.g., ratios of cache to DRAM assignment or fixed allocation) and proportional allocation based on the ratio of flash to DRAM memory capacity.

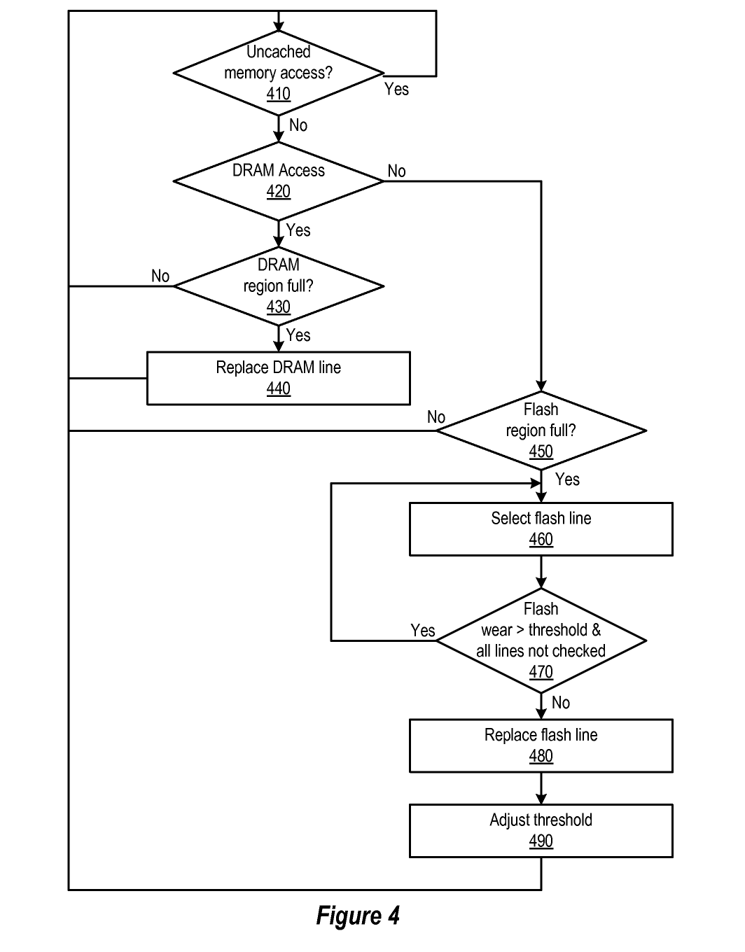

FIG. 4 shows a flow chart of the operation of a cache management system 120. More specifically, during operation, the cache management system 120 determines whether a memory access is an uncached memory access at step 410. If so, then the cache management system 120 continues to monitor for the next memory access. If the memory access is a cached memory access as determined at step 410, then the cache management system 120 determines whether the memory access is a DRAM access at step 420. If the memory access is a DRAM access, then the cache management system 120 determines whether the DRAM region of the cache is full at step 430. If the DRAM region of the cache is full, then the cache management system proceeds with replacing a line of the cache within the DRAM region of the cache at step 440 via, for example conventional line replacement algorithms. If the DRAM region of the cache is not full, then the cache management system 120 continues to monitor for the next memory access.

If at step 420, the cache management system 120 determines that the memory access is not a DRAM access (i.e., the memory access is a flash memory access), then the cache management system 120 determines whether the flash region of the cache is full at step 450 and if not, then selects a flash line for replacement at step 460. The line to be replaced may be selected based on any known line replacement algorithm, but can delay replacement of the line pending a line wear check.

The cache management system determines whether the flash wear is greater than a predetermined threshold and whether all lines have not bee check at step 470. The process checks wear on the selected line. In certain embodiments, more sophisticated wear leveling algorithms may be integrated into a line replacement operation. If the wear is determined to be within acceptable limits, then the line is replaced at step 480 and the threshold of the line is adjusted at step 490. If the wear is determined to be outside of acceptable limits, then another flash line is selected at step 460.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the system 120 can function with different cache levels, multiple cache line sizes in a single cache, and a split cache at the highest level. Additionally, in certain embodiments, the system provides flash support. Additionally, in certain embodiments, the system factors line size into a least recently used (LRU) type algorithm for line replacement. Also in certain embodiments, information regarding the type of target (e.g., whether the target is a DRAM or flash memory) is provided with registers which mirror the memory interface address space partitioning configured at system initialization.

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for optimizing a memory system, the method comprising:
providing the memory system with a memory system cache hierarchy having a plurality of caches, at least one of the caches having a different cache line size;
determining a cache line size for each of the plurality of caches; and,
determining a cache line size based upon the size of a storage device access.

2. The method of claim 1 further comprising:
factoring the cache line size for each of the plurality of caches when performing a least recently used type line replacement operation.

3. The method of claim 1 wherein:
the plurality of caches comprise a dynamic random access memory (DRAM) type cache and a flash memory type cache.

4. The method of claim 3 wherein:
the memory system cache hierarchy comprises a higher level cache; and further comprising: dividing the higher level cache into a DRAM cache and a flash cache.

5. The method of claim 4 further comprising:
setting different cache line sizes in the DRAM cache and the flash cache to enable accessing of these caches to be optimized for respective DRAM burst and flash page sizes.

6. The method of claim 1 wherein:
the plurality of caches are arranged as different cache levels within the memory system cache hierarchy.

7. The method of claim 1 wherein:
a plurality of cache line sizes are included within in a single cache of the memory system cache hierarchy.

8. The method of claim 1 wherein:
at least one of the cache line sizes is optimized to support one or multiple sequential DRAM bursts.

9. A memory system comprising:
a memory system cache hierarchy, the memory system cache hierarchy comprising a plurality of caches, each of the caches having different cache line sizes; and,
a cache management system, the cache management system determining a cache line size for at least one of the plurality of caches; and determining a cache line size based upon the size of a storage device access.

10. The memory system of claim 9 wherein the cache management system:
factors the cache line size for each of the plurality of caches when performing a least recently used type line replacement operation.

11. The memory system of claim 9 wherein:
the plurality of caches comprise a dynamic random access memory (DRAM) type cache and a flash memory type cache.

12. The memory system of claim 11 wherein:
the memory system cache hierarchy comprises a higher level cache; and
the cache management system divides the higher level cache into a DRAM cache and a flash cache.

13. The memory system of claim 12 wherein the cache management system:
sets different cache line sizes in the DRAM cache and the flash cache to enable accessing of these caches to be optimized for respective cache line sizes.

14. The memory system of claim 9 wherein:
the plurality of caches are arranged as different cache levels within the memory system cache hierarchy.

15. The memory system of claim 9 wherein:
a plurality of cache line sizes are included within in a single cache of the memory system cache hierarchy.

16. The memory system of claim 9 wherein:
at least one of the cache line sizes is optimized to support one or multiple sequential DRAM bursts.
